(19) United States
(12) Patent Application Publication
(10) Pub. No.: US 2006/0096155 A1
(43) Pub. Date: May 11, 2006

(54) Reflective fishing lure and method of use

(76) Inventor: Steve Kline, Belton, TX (US)

Correspondence Address: ROBERT GREESON, 900 Washington Avenue, 7th Floor, P.O. Box 1470, Waco, TX, 77603, US

(21) Appl. No.: 10/984,365

(22) Filed: Nov. 8, 2004

(51) Int. Cl. A01K 85/00

(52) U.S. Cl. 43/42.33

(57) ABSTRACT

An improved reflective fishing lure incorporating a plurality of ultra-reflective beads. The reflective beads are between 12-325 US Mesh, 45-1700 Microns, have a roundness greater than or equal to seventy percent, have a refractive index greater than or equal to one and fifty one one hundredths (1.51), and have a specific gravity of approximately two and five tenths (2.5). The lure itself may be transparent, semi-transparent, or substantially opaque. The reflective beads are dispersed through a transparent of semi-transparent lure member; or are dispersed over the outer surface of a substantially opaque lure member.

### BACKGROUND OF THE INVENTION

1. Field of the Invention

The present invention generally relates to a fishing lure. More specifically, the present invention relates to an improved reflective fishing lure that incorporates the use of round, ultra-reflective beads which impart relatively high reflection characteristics to the lure.

2. Background Information

The use of fishing lures, and even those having reflective properties, are known in the art. More specifically, reflective fishing lures heretofore devised and utilized are known to consist basically of familiar, expected, and obvious structural configurations, notwithstanding the myriad of designs encompassed by the crowded prior art which have been developed for the fulfillment of countless objectives and requirements.

Known documents include: U.S. Pat. No. 4,631,854 (“Rosko”) and U.S. Pat. No. 5,044,110 (“Henderson”). Rosko relies on fragmented reflective surfaces to provide a glistening effect along the surface of the lure. Henderson teaches a lure having an enclosed inner body containing a fluid and particle (such as glitter) combination that is agitated as the lure moves.

While these devices may fulfill their respective, particularly claimed objectives and requirements, the aforementioned documents do not disclose a reflective fishing lure having the unique and novel attribute of the present invention.

Reflective fishing lures known in the art simply fall short in view of the present invention. Applicant's invention, through employment of ultra-reflective beads, provides a fishing lure having reflective properties not achieved in known devices.

Early on, mankind relied on fishing as a means of survival; however, over the years fishing has evolved from solely a means of survival to a sport. And, while the reasons for fishing itself have changed, so have the methods employed. While the first fisherman may have relied on rudimentary spears, nets, or even their bare hands to capture fish-today anglers heavily rely on artificial lures.

There is a variety of surprisingly sophisticated fishing lures available to bolster the success of any fisherman. These lures come in a surprisingly wide variety of shapes, sizes, and colors. This, in part, is a result of the fact that each size, shape, and color scheme of a particular lure strongly affect the success or failure of a fisherman under particular conditions. For example, a lure having reflective properties may be particularly useful for top water use on a sunny day. That is, as the lure is reeled in it will shimmer in the sun in a manner to attract surrounding fish. Also, a highly reflective “soft worm” lure may be effective to strongly reflect smaller amounts of incident light at mid level water depths.

An overwhelming majority of anglers agree in one very important aspect-artificial lures, and particularly those with reflective properties, are far superior in catching fish and ease of use when compared to natural bait. It is estimated that out of all the professional or semi professional fish anglers, ninety percent prefer the use of artificial lures over live bait. Such is the result for several reasons. Artificial lures can be easily switched out with one another to maximize productivity according to changing conditions. Also, artificial lures are generally cheaper than live bait. Finally, artificial lures are extremely durable—they can be used over an over again, while live bait obviously has a short operating life.

The development of better lures is further spurred on by the ever-increasing popularity of fishing as a sport. In fact, there is a constantly growing number of publications dedicated to the sport of fishing. Morever, it is not uncommon to come across television programming dedicated solely to fishing. In light of the growing popularity of the sport, and the endless combinations for lure design, a tremendous amount of time and effort is devoted to producing the very best lure. It is not uncommon for a company to spend several thousands of dollars on the research and development of a single artificial lure alone.

Despite the tremendous variety in available lures and their technological advances in recent years, all currently available lures are limited in view of Applicant's invention. That is, while a staggering amount of time and effort has been dedicated to developing the most effective size, shape, and color combination for particular lures, each of these lures lacks an important dimension provided by the present apparatus.

Applicant's invention provides an artificial lure in combination with ultra reflective beads to entice surrounding fish. The artificial lure may be opaque, having beads placed on the surface of the lure; or the lure may be transparent or semi-transparent, having reflective beads dispersed within the lure. As mentioned, these beads are highly reflective. In fact, their reflective properties are strong enough so that the beads are typically used as in reflective road surface materials.

In view of the limitations associated with available lures, a great need exists for an artificial lure that offers the same benefits as available lures and additionally attracts fish via ultra-reflective beads. Applicant's invention, as will be fully discussed in the specification to follow, through its numerous embodiments, provides such a lure. Applicant's invention provides a new approach for enticing fish to strike the lure. Further, the present invention is associated with high quality components and a relatively straightforward and efficient manufacturing process. Finally, the invention has near perfect reflective symmetry and is capable of reflecting a very high percentage of incident light. Such is the result as

### SUMMARY OF THE INVENTION

The general purpose of the present invention, which will be described subsequently in greater detail, is to provide an improved reflective fishing lure having features that result in a new lure which is not anticipated, rendered obvious, suggested, or even implied by any of the known fishing lures, either alone or in any combination thereof.

In view of the foregoing, it is an object of the present invention to provide an improved reflective fishing lure and method of use where ultra reflective beads are distributed though the lure.

It is another object of the present invention to provide an improved reflective fishing lure and method of use where ultra reflective beads are distributed along the outer surface of the lure.

It is another object of the present invention to provide an improved reflective fishing lure and method of use that has a comparatively high reflective value.

It is another object of the present invention to provide an improved reflective fishing lure and method of use that is comparatively useful in attracting fish.

It is another object of the present invention to provide an improved reflective fishing lure and method of use that is economically available to the general public.

In view of the foregoing and other related objects, Applicant's invention provides an extremely reflective fishing lure. Lures having reflective properties, ask known in the art, are useful in catching fish. It is further known in the art that the more reflective the lure, the more likely the fish will strike the lure. Therefore, it naturally follows that the effectiveness of the lure is often directly related to its reflective properties.

Applicant's invention exploits this accepted notion. That is, Applicant's invention combines different types of lures with highly reflective beads. In it most useful forms, the present device incorporates the use of beads such as SWARCOLUX or MEGALUX beads produced by Swarco Reflex, Inc. of Mexia, Tex. Traditionally, such beads are used in reflective road surface materials, and are renowned for their superiority in directly reflecting a high percentage of incident light. These beads, used in combination with a variety of lure members, provide an effective device for luring in fish.

Various embodiments of the present invention are envisioned where the lure is of an opaque, transparent or semi-transparent configuration. Embodiments involving a transparent or semi transparent lure will be combined with the reflective beads during its formative stage. That is, before the lure member dries and hardens, reflective beads will be combined with other ingredients such as gelatin, plastics, and flavoring agents. As a result, the reflective beads will be distributed throughout the body of the soft lure member—providing unique, three dimensional reflective effects. An additional advantage is found in using such beads in the lure member. The beads have been found to impart an added weight to the lure sufficient to eliminate the need for additional weights to effectively use the lure.

Embodiments involving opaque lure members may be treated with the ultra-reflective beads so that a plurality of beads is distributed along the lure surface. In such cases these reflective members are mixed with a finish mixture to be applied to the lure itself. This finish mixture may be any of a variety of enamel, paint, or gloss type mixtures. Importantly, the reflective beads remain bound in the mixture as it dries and hardens, yet retain virtually all of the reflective properness. In this fashion, lures may be painted by hand or in an automated fashion with a bead-containing mixture. In its final form, the opaque lure will may take on any number of desired color schemes, all the while retaining its ultra-reflective properties.

### BRIEF DESCRIPTION OF THE DRAWINGS

FIG. 1 is a perspective view of preferred embodiment of the device for attracting fish of the present invention.

FIG. 2 is a perspective view of an alternative embodiment of the device for attracting fish of the present invention.

### DETAILED DESCRIPTION OF THE PREFERRED EMBODIMENT

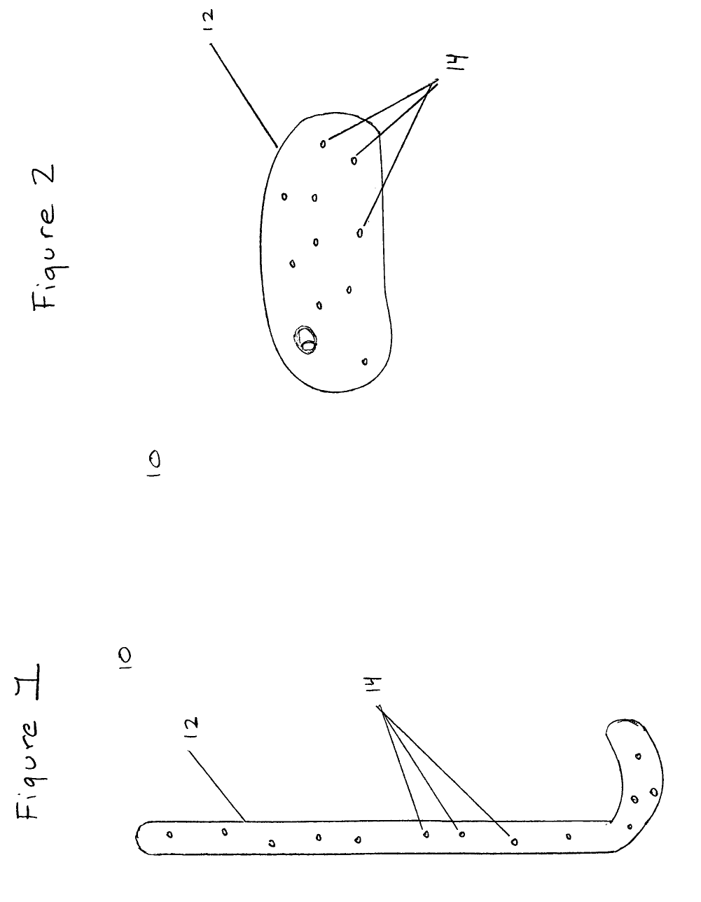

Referring to FIG. 1, the device of the present invention is generally designated by the reference numeral 10. Device 10, in the preferred embodiment is generally characterized by a transparent or semi transparent lure member 12. In this embodiment lure member 12 has a general configuration of that of a “soft worm” lure. As such, the general process of manufacture remains largely the same as those known in the art. That is, lure member 12 is made of the same general components and retains the general characteristics of those “soft warm” lures known in the art.

The novelty of device 10 largely comes from use of reflective beads 14 in combination with lure member 12. In the preferred embodiment, reflective beads 14 are glass beads that possess ultra reflective properties. These ultra reflective properties are the result of the size, roundness, refractive index, and specific gravity of each bead.

Reflective beads 14, as used in device 10, have a size range of between 12 and 325 US Mesh, 45 and 1700 Microns, a roundness greater than or equal to seventy percent, a refractive index of greater than or equal to one and fifty one one hundredths (1.51), and a specific gravity greater than or equal to two and five tenths (2.5). However, in its most preferred form, device 10 contains reflective beads 14 where reflective beads 14 have a size range of between 12 and 30 US Mesh, 600 and 1700. Microns, a roundness greater than or equal to ninety percent, a refractive index of greater than or equal to one and fifty one one hundredths (1.51), and a specific gravity greater than or equal to two and five tenths (2.5). Such reflective beads 14 may those such as MEGALUX-BEADS as manufactured by Swarco Reflex, Inc. of Mexia, Tex. These beads possess reflective properties such that they are renowned for their superiority in use in reflective road surfaces. The “retroreflective” properties of these beads are such that beads directly reflect a very large percentage of incident light. As such, combining such beads with lures provides for an extremely effective device in attracting fish.

As mentioned, in the preferred embodiment, reflective beads 14 are dispersed through lure member 12. This is accomplished by mixing reflective beads 14 with lure member 12 in its formative stage. That is, as lure member 12 is being formed and before it dries, reflective beads 14 are mixed with other lure ingredients. These ingredients may include gelatin products and flavor agents such as salt. Such process produces a lure that has reflective properties beyond any other lures known in the art.

Other embodiments are envisioned where lure member 12 is of a substantially opaque configuration. In such embodiments, lure member 12 is generally comprised of a hard plastic. Commonly these take the form of various top water lures such as spinner baits or shad lures as known in the art. In such an embodiment, reflective beads 14 are distributed over the outer surface of lure member 12 to impart ultra reflective properties upon device 10. Reflective beads 14 may be applied by hand or in automated fashion and may be combined with other ingredients to form an ultra reflective “finishing layer” on device 10. Commonly, reflective beads 14 will be mixed with some solvent-based or water-based paint, an epoxy, a urethane, or some plastic material and then applied to the outer surface of lure member 12.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An device for attracting fish, comprising:
a lure member
where said lure member is comprised of a transparent or semi-transparent material;
a plurality of reflective beads
where said beads are dispersed through said lure member, where said beads are between 12-325 US mesh, 45-1700 microns, have a roundness greater than or equal to seventy percent, have a refractive index greater than or equal to one and fifty one one hundredths (1.51), and have a specific gravity of approximately two and five tenths (2.5).

2. The device of claim 1, where
said reflective beads are between 20-325 US Mesh, 45-850 microns, have a roundness greater than or equal to seventy percent, have a refractive index greater than or equal to one and fifty one one hundredths (1.51), and have a specific gravity of approximately two and five tenths (2.5).

3. The device of claim 1, where
said reflective beads are between 14-200 US Mesh, 75-1400 Microns, have a roundness greater than or equal to eighty percent, have a refractive index greater than or equal to one and fifty one one hundredths (1.51), and have a specific gravity of approximately two and five tenths (2.5).

4. The device of claim 1, where
said reflective beads are between 12-30 US Mesh, 600-1700 Microns, have a roundness greater than or equal to ninety percent, have a refractive index greater than or equal to one and fifty one one hundredths (1.51), and have a specific gravity of approximately two and five tenths (2.5).

5. An device for attracting fish, comprising:
a lure member
where said lure member is comprised of a substantially opaque material, and where said lure member has an outer surface configured to receive a plurality of reflective beads;
said plurality of reflective beads
where said beads are dispersed over said lure member outer surface, where said beads are between 12-325 US Mesh, 45-1700 Microns, have a roundness greater than or equal to seventy percent, have a refractive index greater than or equal to one and fifty one one hundredths (1.51), and have a specific gravity of approximately two and five tenths (2.5).

6. The device of claim 5, where
said reflective beads are between 20-325 US Mesh, 45-850 Microns, have a roundness greater than or equal to seventy percent, have a refractive index greater than or equal to one and fifty one one hundredths (1.51), and have a specific gravity of approximately two and five tenths (2.5).

7. The device of claim 5, where
said reflective beads are between 14-200 US Mesh, 75-1400 Microns, have a roundness greater than or equal to eighty percent, have a refractive index greater than or equal to one and fifty one one hundredths (1.51), and have a specific gravity of approximately two and five tenths (2.5).

8. The device of claim 5, where
said reflective beads are between 12-30 US Mesh, 600-1700 Microns, have a roundness greater than or equal to ninety percent, have a refractive index greater than or equal to one and fifty one one hundredths (1.51), and have a specific gravity of approximately two and five tenths (2.5).
